(19) United States
(12) Patent Application Publication
(10) Pub. No.: US 2017/0096356 A1
(43) Pub. Date: Apr. 6, 2017

(54) PROCESS AND SYSTEM FOR PRODUCED WATER TREATMENT

(71) Applicant: SAAD A. Al-Jlil, RIYADH (SA)

(72) Inventor: SAAD A. Al-Jlil, RIYADH (SA)

(73) Assignee: King Abdulaziz City for Science and Technology (KACST), RIYADH (SA)

(21) Appl. No.: 14/875,698

(22) Filed: Oct. 6, 2015

Related U.S. Application Data
(63) Continuation-in-part of application No. 14/875,695, filed on Oct. 6, 2015.

(51) Int. Cl. C02F 9/00; C02F 1/14; C02F 1/28; C02F 1/52; B01D 61/36; B01D 1/02; B01D 3/10; B01D 3/14; B01D 53/04; C02F 1/06; B01D 1/00

(52) U.S. Cl. CPC C02F 9/00; C02F 1/06; C02F 1/14; C02F 1/28; C02F 1/52; B01D 1/0035; B01D 1/02; B01D 3/10; B01D 3/143; B01D 53/04; B01D 61/364; C02F 2001/5218; C02F 2103/10

(57) ABSTRACT

There is provided a process and system for treating produced water. The process combines a vacuum tank process, an adsorption-desorption process, a heat-exchanger process, a membrane distillation-crystallization process. Also, the process may involve membrane separation and column distillation processes. The process allows for some level of efficiency with regard to energy consumption and operational and maintenance costs.

### CROSS REFERENCE TO RELATED APPLICATION

This application is a continuation in part and claims priority to U.S. patent application Ser. No. 14/875,695 filed on Oct. 6, 2015. U.S. patent application Ser. No. 14/875,695 is hereby incorporated by reference in their entireties for all their teachings.

### FIELD OF TECHNOLOGY

This disclosure relates generally to the treatment of produced water for the production of water which may be drinking water, water that may be discharged safely in the environment or water that may be reuse in an oil and gas production facility. More specifically, this disclosure relates to a produced water treatment process that combines adsorption-desorption, membrane distillation and crystallization processes. Also, the process may involve membrane separation and column distillation processes.

### BACKGROUND

Produced water is water from underground formations that is brought to the surface during oil production. It is also referred to as a brine, salt water, or formation water. Generally, produced water is composed of dispersed oil, dissolved organic compounds, production chemicals, heavy metals and natural radioactive minerals. Some of these elements occur naturally in produced water while others relate to chemicals that have been added for well-control purposes (Hamid H A et al., 2008). Produced water characteristics and physical properties vary considerably depending on the geographic location of the field, the geological formation with which the produced water has been in contact for thousands of years and the type of hydrocarbon product being produced (Hamid H A et al., 2008; Veil J A et al., 2004). Also, the volume of produced water from oil and gas wells does not remain constant over time. The water-to-oil ratio increases over the life of the oil or gas well. For example, a small amount of produced water is expected when the well is new. Overtime, the percentage of water increases and the percentage of oil or gas declines (Veil J A et al., 2004). Moreover, additional water is often needed to maintain sufficient pressure in a reservoir for oil production. Produced water may be reused for this purpose, but the water may also be supplied from additional sources including groundwater and seawater (Veil J A et al., 2004).

Produced water is the largest volume by-product or waste stream associated with oil and gas production. For inland oil production facilities, more than 60% of produced water is commonly re-injected back into the wells (Mondal S et al., 2008), Veil et al. (2004) reported that U.S. wells produce an average of seven barrels of water for each barrel of oil. Produced water may have different potential impacts on the environment depending on where it is discharged. Produced water presents a potential environmental threat to surface, underground water and soil. The oil and gas industry requires huge quantities of fresh water, which is a challenge, especially in coastal and arid regions. Treatment and reuse of produced water thus provide an alternative and sustainable way for fresh water resource for the oil and gas industry. Mondal et al. (2008) state that development of economical treatment processes for produced water is vital for two reasons: 1—it could provide a viable source of new water for beneficial use; 2—economical and environmentally friendly methods of disposal of produced water are vital in order to prevent serious environmental damage.

Different treatment technologies are proposed to treat wastewater such as physical, membrane separation, chemical and biological methods. The high cost treatment, toxic chemical usage and space requirements for installation are the main drawbacks of chemical and biological methods (Ahmaduna F et al., 2009). Moreover, conventional oily wastewater treatment methods such as gravity separation and skimming have several disadvantages such as low efficiency, high operating costs, corrosion, and recontamination problems (Mueller J et al., 1997; Li Y S et al., 2006).

There is still a need for simple, energy-efficient and cost-effective processes for treating produced water to produce treated water which may be drinking water, water that may be discharged safely in the environment or water that may be reuse in an oil and gas production facility.

### SUMMARY

This disclosure relates to a process for treating well water to produce water which may be drinking water, water that may be discharged safely in the environment or water that may be reuse in an oil and gas production facility. The process of this disclosure combines a vacuum tank process, an adsorption-desorption process, a heat-exchanger process, a membrane distillation-crystallization process. Also, the process may involve separation and column distillation processes. The process of this disclosure allows for some level of efficiency with regard to energy consumption and operational and maintenance costs. Indeed, the required pressure is about 1 bar, which is low comparing to pressures of about 40-60 bars required in reverse osmosis (RO).

Several embodiments for the process and associated system of this disclosure are outlined below. According to an aspect, this disclosure relates to a process for treating produced water, comprising: (a) heating produced water to a temperature of about 60 to 90° C.; (b) submitting the heated produced water to a vacuum tank process to obtain water vapor and a mixture of brine and oil; (c) submitting the water vapor to adsorption and desorption processes in an adsorption-desorption unit having one or more columns; (d) submitting the water vapor from step (c) to a heat-exchange process to obtain the treated water, wherein heat is exchanged between the water vapor and the mixture of brine and oil from step (b); and (e) submitting the mixture of brine and oil obtained from step (d) to a membrane distillation process to obtain treated water and a mixture of brine and oil, the treated water being combined with the treated water obtained at step (d).

In one embodiment, the process further comprises: (f) submitting the mixture of brine and oil from step (e) to a crystallization process to obtain a mixture of water and oil vapors and salt; and (g) submitting the mixture of water and oil vapors to a column distillation process to obtain water vapor and residual oil, wherein the water vapor is combined with the water vapor obtained at step (c).

In one embodiment, the process further comprises: (f1) submitting the mixture of brine and oil from step (e) to a membrane separation process to obtain brine and residual oil, optionally the separation process comprises using a ceramic membrane; and (f) submitting the brine from step (f1) to a crystallization process to obtain water vapor and salt, wherein the water vapor is combined with the water vapor from step (c).

In one embodiment, the process further comprises a step of (al) adding an anti-scalant to produced water prior to step (a). In one embodiment, at step (a), heating is performed with solar energy. In one embodiment, at step (c), the water vapor is adsorbed on a hydrophilic adsorbent. In one embodiment, step (c) comprises simultaneously sparging air during the adsorption process.

In one embodiment, at step (c), the water vapor is desorbed from a hydrophilic adsorbent by passing produced water into coils of the one or more columns, and the process comprises the further step of (c1) mixing the produced water from the coils with the heated produced water, optionally heating is performed with solar energy.

In one embodiment, step (e) comprises contacting one side of a porous hydrophobic membrane with brine, while contacting the other side of the membrane with tap water or with the treated water obtained at steps (d) and (e).

In one embodiment, the process further comprises a step of (h) submitting the treated water to a cooling step. In one embodiment, step (c) is performed simultaneously in two or more columns of the adsorption-desorption unit, the water vapor obtained from the columns being combined prior to step (d).

In one embodiment, the treated water is drinking water, water that may be discharged safely in the environment or water that may be reuse in an oil and gas production facility.

According to another aspect, this disclosure relates to a system for produced water treatment, comprising: a heating unit; a vacuum tank; an adsorption-desorption unit having one or more columns; and a heat-exchanger, wherein the heating unit is operably connected to a produced water tank such that the produced water is heated at a temperature of about 60 to 90° C., and the heated produced water is fed to a vacuum tank to obtain water vapor which is fed to the adsorption-desorption unit, and the water vapor exiting the adsorption-desorption unit is fed to the heat-exchanger wherein heat is exchanged between the water vapor and a mixture of brine and oil from the vacuum tank yielding a treated water which is collected in a collector tank and a mixture of brine and oil.

In one embodiment, the system further comprises: a membrane distillation unit; a crystallizer unit; and a column distillation unit, wherein the mixture of brine and oil is fed to the membrane distillation unit yielding a mixture of brine and oil vapors and salt, and the mixture of brine and oil vapors is fed to the column distillation unit yielding water vapor and residual oil.

In one embodiment, the system further comprises: a membrane distillation unit; a separation unit; and a crystallizer unit, wherein the mixture of brine and oil is fed to the membrane distillation unit yielding a mixture of brine and oil vapors and salt, and the mixture of brine and oil vapors is fed to the membrane separation unit yielding brine and residual oil, and brine is fed to the crystallizer unit yielding water vapor and salt.

In one embodiment, each column each comprises a hydrophilic adsorbent and coils. In one embodiment, a distillation membrane in the membrane distillation-crystallization unit is a porous hydrophobic membrane. In one embodiment, the membrane separation unit comprises a ceramic membrane. In one embodiment, the heating unit comprises a solar energy system. Other features will be apparent from the accompanying drawings and from the detailed description that follows.

### BRIEF DESCRIPTION OF DRAWINGS

Example embodiments are illustrated by way of example and not limitation in the figures of the accompanying drawings, in which like references indicate similar elements and in which:

FIG. 1 outlines an embodiment of the produced water treatment process of this disclosure.

FIG. 2 outlines another embodiment of the produced water treatment process of this disclosure.

Other features of the present embodiments will be apparent from the accompanying drawings and from the detailed description that follows.

### DETAILED DESCRIPTION

In order to provide a clear and consistent understanding of the terms used in the present disclosure, a number of definitions are provided below. Moreover, unless defined otherwise, all technical and scientific terms as used herein have the same meaning as commonly understood to one of ordinary skill in the art to which this disclosure pertains.

The use of the word “a” or “an” when used in conjunction with the term “comprising” in the claims and/or the description may mean “one”, but it is also consistent with the meaning of “one or more”, “at least one”, and “one or more than one”. Similarly, the word “another” may mean at least a second or more.

As used herein, the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein, the term “about” is used to indicate that a value includes an inherent variation of error for the device or the method being employed to determine the value.

The disclosure is drawn to a process for treating well water to produce water which may be drinking water, water that may be discharged safely in the environment or water that may be reuse in an oil and gas production facility. The process of this disclosure combines a vacuum tank process, an adsorption-desorption process, a heat-exchanger process, a membrane distillation-crystallization process. Also, the process may involve separation and column distillation processes. The process of this disclosure allows for some level of efficiency with regard to energy consumption and operational and maintenance costs. Indeed, the required pressure is about 1 bar, which is low comparing to pressures of about 40-60 bars required in reverse osmosis (RO).

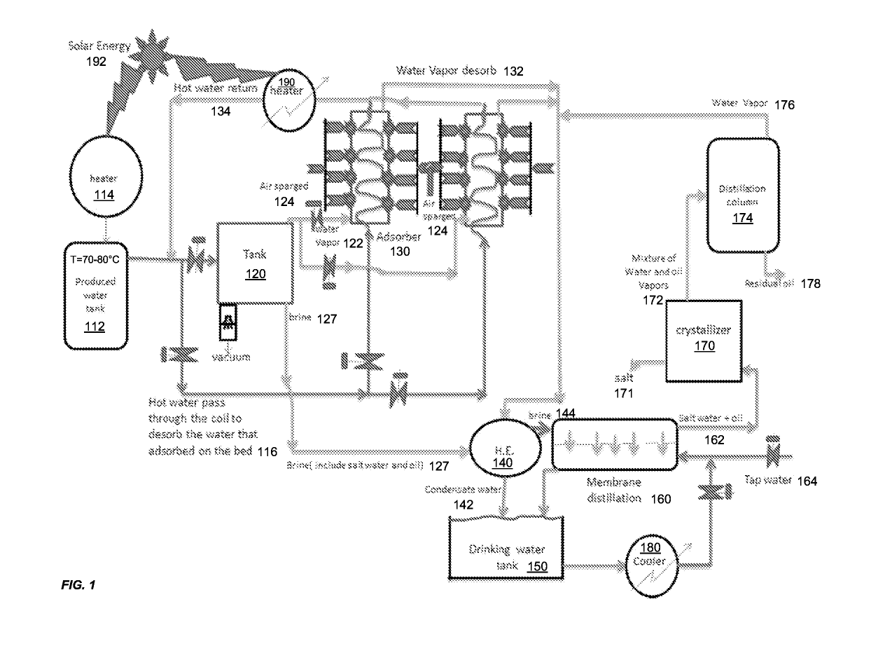

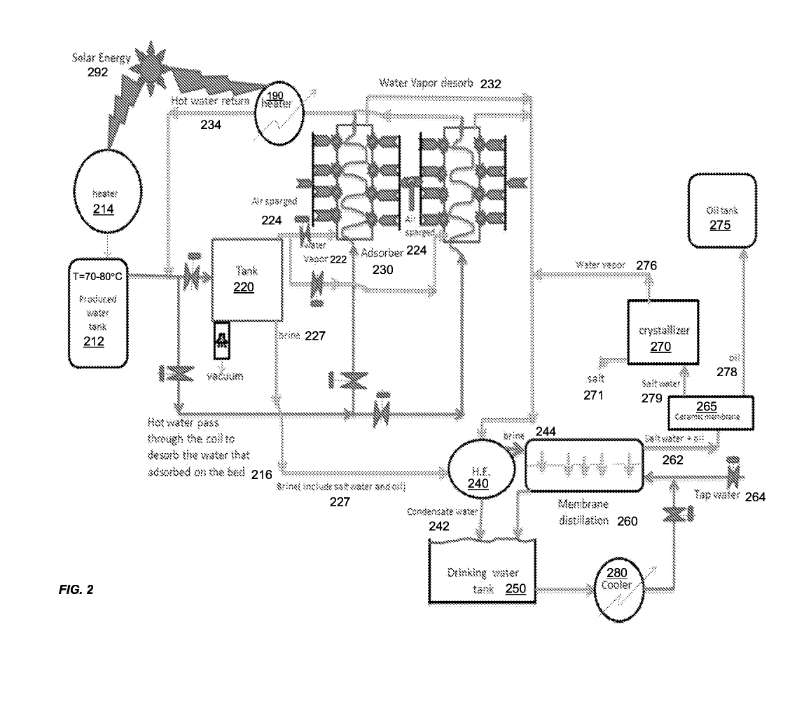

More specifically, the process comprises the following three phases: 1—a vacuum tank process conducted in a vacuum tank, 2—adsorption and desorption processes conducted in an adsorption-desorption unit, and 3—a membrane-distillation process followed by a crystallization process conducted in a membrane distillation-crystallization system. In one embodiment, a mixture of water and oil vapors from the crystallizer is further submitted to a column distillation process. In another embodiment, a mixture of salt water and oil from the membrane-distillation process is submitted to a membrane separation process and the salt water obtained is submitted to the crystallizer. Details on each of the three phases as well as these embodiments are outlined below with reference to FIG. 1 and FIG. 2.

### Vacuum Tank

Typically, a vacuum tank process is a process of causing the pressure http://en.wikipedia.org/wiki/Pressure in a water-filled container to be reduced below the vapor pressure http://en.wikipedia.org/wiki/Vapor_pressure of the water, thus causing water to evaporate at a lower temperature than normal. In this disclosure, the interior pressure of the tank is reduced below atmospheric pressure. This reduces the boiling point of water to be evaporated. Firstly, produced water from a produced water tank 112, 212 is heated using a heater 114, 214. The energy source or heater 114, 214 may be solar energy 192, 292 using ultra high concentrator photovoltaic (UHCPV) or any suitable energy providing means. The heated produced water (temperature of about 70-80° C.) is pumped into the vacuum tank 120, 220 resulting in the evaporation of water. This process also yields a mixture of salt water and oil 127, 227. An anti-scalant material may be added to the heated produced water prior to its introduction into the vacuum tank. The water vapor exiting the vacuum tank 122, 222 is directed to the adsorption-desorption unit (adsorber) 130, 230.

### Adsorption-Desorption Unit

The adsorption-desorption unit 130, 230 may comprise one column or more. Each column is continually switched between adsorption process and desorption process.

During the adsorption process, the water vapor from the vacuum tank 122, 222 is adsorbed on a hydrophilic adsorbent which may be a nano-bentonite clay or a clay-carbon nanocomposite or a zeolite-carbon nanocomposite or a chitosan-clay nanocomposite. Also during the adsorption process, air is sparged (pushed) 124, 224 to the adsorbent bed inside the column. This is done using an air distributer to enhance the mass transfer of the water vapor to the adsorbent bed. The adsorption rate of the water vapor on the hydrophilic adsorbent bed is thus enhanced. Air may be used at its normal temperature. After a period of time, for example 10 minutes, the adsorbent bed is saturated. The adsorption process may be switched to another column and the process continues. Meanwhile, desorption process is started on the first column.

Desorption is the reverse of adsorption. Typically, desorption is a process whereby a substance (water vapor) is released from the surface of the adsorbent bed in the column (http://en.wikipedia.org/wiki/Phenomenon). The desorption process is operated by passing the heated produced water through coils inside the column 116, 216. The heated water introduced in the coils may include and anti-scalant material. Heat from the heated water inside the coils is transferred to the bed column and desorbs water that is adsorbed on the adsorbent bed. Water is released in the form of vapor 132, 232 and leaves the column. The desorption process cleans the adsorbent bed and regenerates the adsorbent. Water introduced through coils inside the column 116, 216 for the desorption process exits the absorber unit and is returned in the system 134, 234. Optionally this water is heated before being fed to the system. Heating may be performed using a heater 190, 290 which may be solar energy 192, 292 or any suitable energy providing means.

The water vapor exiting the columns 132, 232 is directed to a heat-exchanger (HE) 140, 240 to condense 142, 242 yielding the treated water which is collected into a treated water tank 150, 250. The treated water may be drinking water, water that may be discharged safely in the environment or water that may be reuse in an oil and gas production facility.

In the heat-exchanger, heat is axchanged between the water vapor 132, 232 and a mixture of salt water (brine) and oil 127, 227 coming from the vacuum tank 120, 220. More specifically, the water vapor 132, 232 transfers its energy to the mixture of salt water and oil 127, 227. The temperature of the mixture of salt water and oil is thus increased. This hot mixture of salt water and oil 144, 244 is submitted to membrane distillation 160, 260 for further treatment including desalination.

As indicated above, an anti-scalant material may be added to the heated produced water prior to its introduction in the columns. This prevents scaling on the surface the coils in the columns of the adsorption-desorption unit. Such material may be for example a Hf anti-scalant material, a Epson-Hf anti-scalant material or an acid such as H₂SO₄.

When the adsorption-desorption unit 130, 230 has two or more columns, the adsorption and desorption processes continue without interruption as the two or more columns are continually switched between adsorption and desorption.

### Membrane Distillation-Crystallization (MDC)

Membrane distillation-crystallization is a combination of membrane distillation (MD) process and crystallization process. The membrane-distillation yields treated water 150, 250 and a concentrated mixture of salt water and oil 162, 262.

In one embodiment, as illustrated for example in FIG. 1, the mixture of salt water and oil 162 is directed to a crystallizer 170 for the crystallization process which yields salt 171 and a mixture of water and oil vapors 172. The mixture of water and oil vapors 172 is further fed to a distillation column 174 to obtain water vapor 176 and residual oil 178. The water vapor 176 may be fed back to the heat-exchanger 140. And the salt (solid) from the crystallizer 170 may be used as a new adsorbent to adsorb heavy metals from waste water. Accordingly, in the process of this disclosure, use of a crystallizer leads to no concentrated water being discharged in the environment.

In another embodiment, as illustrated for example in FIG. 2, the mixture of salt water and oil 262 is directed to a membrane separation unit 265 which may be involve a membrane ceramic. Oil obtained in the separation process 278 is directed to an oil tank 275, and salt water obtained 279 is fed to a crystallizer 270 yielding salt 271 and water vapor 276. The water vapor 276 may be fed back to the heat-exchanger 240. And the salt (solid) from the crystallizer 270 may be used as a new adsorbent to adsorb heavy metals from waste water. Accordingly, in the process of this disclosure, use of a crystallizer leads to no concentrated water being discharged in the environment.

The membrane distillation process involves a distillation membrane, which may be a porous hydrophobic membrane such as a micro-porous hydrophobic hollow fiber membrane. Such membrane allows for the use of a pressure equal to the natural atmospheric pressure (i.e., equal to 1 bar). An example of such porous hydrophobic membrane is poly(vinylidene fluoride) (PVDF) membrane which is commercially available. This polymer presents several properties that are attractive for membrane distillation application. For example, contrary to other fluoro-polymers since PVDF gives rise to smooth surfaces. This reduces the formation of bio-organic films and bacterial colonies. Also, PVDF is resistant to a wide variety of corrosive chemicals and organic solvents, including strong acids, chlorine, caustic solutions and strong oxidizing agents. The mechanical properties of PVDF remain good in a wide range of temperatures. Moreover, PVDF shows a high durability in ambient and sub-ambient conditions.

In embodiments of this disclosure, the porous hydrophobic membrane may have a pore size of about 0.002-4 μm. Also, in order to enhance the hydrophobicity of the PVDF membrane, a polyvinylpyrrolidone may be added. Moreover, a micro-size membrane allows for an easy maintenance and backwash. Adoption of a proper feed flow also helps in the maintenance of the membrane.

Other suitable porous hydrophobic membranes may include for example polytetrafluoroethylene (PTFE), trimethylchlorosilane (TMS) and polydimethylsiloxane (PDMS).

In the membrane distillation process, the liquid feed is hot (temperature of about 70-80° C.) and is brought into contact with one side of the hydrophobic membrane. On the membrane permeate side, tap water 164, 264 is provided, only at the beginning of the run (suggested at room temperature 25° C.), in direct contact with the permeate side of the membrane to maintain the mass transfer driving force, which is the water vapor partial pressure across the membrane. This configuration is known as the direct contact membrane distillation (DCMD). After that, treated water that is collected in the treated water tank 150, 250 will be circulated in counter-current. This makes the system more cost-efficient. Circulation of the drinking water is made in a continuous manner at a fixed temperature of about 25° C. Optionally, the treated water may be cooled using a cooler 180, 280 before being circulated.

The operating temperatures in the process of this disclosure may be maintained at a temperature as low as 50° C. and the operating pressure is around the natural atmospheric pressure (equal to about 1 bar). Accordingly, the process is energy-efficient and cost effective. Moreover, membrane distillation is generally known to present advantages such as low operating pressures, use of modest temperatures, potentially complete retention of nonvolatile solutes and high purity of permeate water (drinking water). In addition, use of a heat-exchanger (instead of a condenser) enhances the cost-efficiency of the process of this disclosure. The process of this disclosure may be implemented in a plant or system with a piping that is made thin, since the required pressure is low. Accordingly, the production cost of the plant is also low comparing to a plant for reverse osmosis (RO). The process of this disclosure does not require use of cartridge filter, nanofilter, high pressure pumps or the like. Accordingly, the operation cost is low.

### Example 1

Referring to FIG. 1, produced water from a produced water tank 112 is heated using a heater 114 at a temperature of about 70-80° C. An anti-scalant material may be added to the heated produced water prior to pumped into the vacuum tank 120. Then, water vapor exiting the vacuum tank 122 is passed to the adsorption-desorption unit 130 to adsorb the water vapor on the hydrophilic adsorbent bed. In the columns of the adsorption-desorption unit 130, air is sparged (passed) 124 to the adsorbent bed to enhance the mass transfer of the water vapor to the adsorbent, hence, to enhance the adsorption rate of the water vapor on the adsorbent bed. This process continues for a period of time, for example 10 minutes, or up to the saturation of the adsorbent bed, then the bed is switched to be desorber by passing heated produced water through the coils inside the columns 116 to transfer the heat to the adsorbent bed to desorb the water from the bed as water vapor 132. This water vapor 132 then passes through a heat-exchanger (HE) 140 to condense 142 into treated water which is collected in a tank 150. The process of adsorption-desorption continues. After that, water from the coils 134 which may be heated using a heater 190 goes back to be mixed with the heated produced water.

The mixture of salt water and oil 127 from the vacuum tank 120 passes to the membrane distillation (MD) 160. Before entering the MD, this mixture of salt water and oil 127 gains energy from the heat-exchanger (HE) and its temperature increases. This hot mixture of salt water and oil 144 then passes to the membrane distillation 160.

In the membrane distillation process, PVDF is used as porous hydrophobic membrane. The water feed which is the hot mixture of salt water and oil 144 is brought into contact with one side of the membrane. On the membrane permeate side, treated water is collected in a continuous manner and stored in the treated water tank 150 which may be a drinking water tank. A concentrated mixture of salt water and oil from the membrane distillation 162 is fed to the crystallizer 170. Treated water from the membrane distillation is mixed with the treated water from the heat-exchanger into the treated water tank 150. The crystallization process in the crystallizer 170 yields salt 171 and a mixture of water and oil vapors 172. This mixture is fed to a distillation column 174. Residual oil 178 is recovered and water vapor exiting the distillation column 176 is returned in the system by mixing it with water vapor from the adsorption-desorption unit 132 prior to being directed to the heat-exchanger 140.

### Example 2

Referring to FIG. 2, the system is operated as described above for Example 1, up until passing the heated mixture of salt water and oil to membrane distillation 260. The concentrated mixture of salt water and oil is then submitted to a separation process which may involve passing the mixture on a ceramic membrane 265. As will be understood by a skilled person any suitable separation means may be used in the separation process. This process yields oil which is collected in an oil tank 275 and salt water 279 which fed to the crystallizer 270. The crystallization process yields salt 271 and water vapor 276. The water vapor 276 is returned in the system by mixing it with water vapor from the adsorption-desorption unit 232 prior to being directed to the heat-exchanger 240.

As will be understood by a skilled person, the process and associated system of this disclosure presents various advantages as outlined above. In addition, salt water or brine disposal is becoming a huge problem as a consequence of the extensive application of reverse osmosis technology for desalination purposes. The process of this disclosure leads to a solid waste which, as outlined above, may be used in the recovery of heavy metals in water. The process also allows for the treatment of water with high concentrations of non-volatile solutes.

Although the present embodiments have been described with reference to specific example embodiments, it will be evident that various modifications and changes may be made to these embodiments without departing from the broader spirit and scope of the various embodiments.

This disclosure refers to a number of documents, the content of which is herein incorporated by reference in their entirety.

### INDUSTRIAL APPLICABILITY

The process of this disclosure is energy-efficient and cost-effective. Use of a heat-exchanger (instead of a condenser) enhances the cost-efficiency of the process. The process of this disclosure may be implemented in a plant or system with a piping that is made thin, since the required pressure is low. Accordingly, the production cost of the plant is also low comparing to a plant for RO. In addition, the process does not require use of cartridge filter, nanofilter, high pressure pumps or the like. The specification and drawings are to be regarded in an illustrative rather than a restrictive sense. This disclosure refers to a number of documents, the content of which is herein incorporated by reference in their entirety.

What is claimed is:

1. A process for treating produced water, comprising:
(a) heating produced water to a temperature of about 60 to 90° C.;
(b) submitting the heated produced water to a vacuum tank process to obtain water vapor and a mixture of brine and oil;
(c) submitting the water vapor to adsorption and desorption processes in an adsorption-desorption unit having one or more columns;
(d) submitting the water vapor from step (c) to a heat-exchange process to obtain the treated water, wherein heat is exchanged between the water vapor and the mixture of brine and oil from step (b); and
(e) submitting the mixture of brine and oil obtained from step (d) to a membrane distillation process to obtain treated water and a mixture of brine and oil, the treated water being combined with the treated water obtained at step (d).

2. The process of claim 1, further comprising:
(f) submitting the mixture of brine and oil from step (e) to a crystallization process to obtain a mixture of water and oil vapors and salt; and
(g) submitting the mixture of water and oil vapors to a column distillation process to obtain water vapor and residual oil, wherein the water vapor is combined with the water vapor obtained at step (c).

3. The process of claim 1, further comprising:
(f1) submitting the mixture of brine and oil from step (e) to a membrane separation process to obtain brine and residual oil, optionally the separation process comprises using a ceramic membrane; and
(f) submitting the brine from step (f1) to a crystallization process to obtain water vapor and salt, wherein the water vapor is combined with the water vapor from step (c).

4. The process of claim 1, further comprising a step of (al) adding an anti-scalant to produced water prior to step (a).

5. The process of claim 1, wherein at step (a) heating is performed with solar energy.

6. The process of claim 1, wherein at step (c) the water vapor is adsorbed on a hydrophilic adsorbent.

7. The process of claim 1, wherein step (c) comprises simultaneously sparging air during the adsorption process.

8. The process of claim 1, wherein at step (c), the water vapor is desorbed from a hydrophilic adsorbent by passing produced water into coils of the one or more columns, and the process comprises the further step of (c1) mixing the produced water from the coils with the heated produced water, optionally heating is performed with solar energy.

9. The process of claim 1, wherein step (e) comprises contacting one side of a porous hydrophobic membrane with brine, while contacting the other side of the membrane with tap water or with the treated water obtained at steps (d) and (e).

10. The process of claim 1, further comprising a step of (h) submitting the treated water to a cooling step.

11. The process of claim 1, wherein step (c) is performed simultaneously in two or more columns of the adsorption-desorption unit, the water vapor obtained from the columns being combined prior to step (d).

12. The process of claim 1, wherein the treated water is drinking water, water that may be discharged safely in the environment or water that may be reuse in an oil and gas production facility.

13. A system for produced water treatment, comprising:
a heating unit
a vacuum tank;
an adsorption-desorption unit having one or more columns; and
a heat-exchanger,
wherein the heating unit is operably connected to a produced water tank such that the produced water is heated at a temperature of about 60 to 90° C., and the heated produced water is fed to a vacuum tank to obtain water vapor which is fed to the adsorption-desorption unit, and the water vapor exiting the adsorption-desorption unit is fed to the heat-exchanger wherein heat is exchanged between the water vapor and a mixture of brine and oil from the vacuum tank yielding a treated water which is collected in a collector tank and a mixture of brine and oil.

14. The system of claim 13, further comprising:
a membrane distillation unit;
a crystallizer unit; and
a column distillation unit,
wherein the mixture of brine and oil is fed to the membrane distillation unit yielding a mixture of brine and oil vapors and salt, and the mixture of brine and oil vapors is fed to the column distillation unit yielding water vapor and residual oil.

15. The system of claim 13, further comprising:
a membrane distillation unit;
a separation unit; and
a crystallizer unit,
wherein the mixture of brine and oil is fed to the membrane distillation unit yielding a mixture of brine and oil vapors and salt, and the mixture of brine and oil vapors is fed to the membrane separation unit yielding brine and residual oil, and brine is fed to the crystallizer unit yielding water vapor and salt.

16. The system of claim 13, wherein each column each comprises a hydrophilic adsorbent and coils.

17. The system of claim 13, wherein a distillation membrane in the membrane distillation-crystallization unit is a porous hydrophobic membrane.

18. The system of claim 13, wherein the membrane separation unit comprises a ceramic membrane.

19. The system of claim 13, wherein the heating unit comprises a solar energy system.
